(19) United States
(12) Patent Application Publication
(10) Pub. No.: US 2025/0071699 A1
(43) Pub. Date: Feb. 27, 2025

(54) NODE RESYNCHRONIZATION MECHANISM FOR WIRELESS BATTERY MANAGEMENT SYSTEM

(71) Applicant: TEXAS INSTRUMENTS INCORPORATED, Dallas, TX (US)

(72) Inventors: Shyam Krishnan VENKATESWARAN, Atlanta, GA (US); Ariton E. XHAFA, Plano, TX (US)

(21) Appl. No.: 18/455,374

(22) Filed: Aug. 24, 2023

(51) Int. Cl. H04W 56/00

(52) U.S. Cl. CPC H04W 56/001; H04L 67/12

(57) ABSTRACT

In an example, a method includes receiving, in a first super frame, a first downlink on a first channel from a wireless master node at a wireless device in a WBMS, where the first downlink indicates a second channel assigned to the wireless device. The method includes transmitting, in the first super frame, a synchronization frame from the wireless device to an unsynchronized wireless device on the second channel, where the synchronization frame indicates a third channel. The method also includes receiving, in the first super frame, the synchronization frame at the unsynchronized wireless device on the second channel. The method includes transmitting, on the third channel in a second super frame after the first super frame, an uplink from the unsynchronized wireless device to the wireless master node.

### BACKGROUND

Modern vehicles may include multiple battery cells. Information associated with the cells, such as temperature, voltage, and other indicators of cell status and health, may be monitored for vehicular safety and to ensure proper operation. In a conventional wired battery management system, rechargeable batteries are managed by circuitry for the safe and efficient operation of the batteries. Wired communication interfaces can be used to connect a main microcontroller (the main node or master node) to each battery module (the secondary nodes), and each battery module is chained to the rest of the battery modules in a daisy chain. With wired communication interfaces, the main microcontroller cannot monitor and control all the battery modules in parallel without complex wiring. This wiring makes repair or replacement of individual battery cells more difficult, and importantly, adds weight and bulk to the overall system.

A wireless connection between the battery modules and the microcontroller makes management of battery modules more flexible and easier to repair. In a wireless battery management system (WBMS), a microcontroller monitors each battery module and communicates with the battery modules using wireless communication interfaces. The main microcontroller controls all the battery modules using a WBMS protocol. Wireless communication interfaces can suffer from wireless communication channel bandwidth variance, interference, and/or other issues, which would prevent proper monitoring and management in a WBMS.

### SUMMARY

In accordance with at least one example of the description, a method includes receiving, in a first super frame, a first downlink on a first channel from a wireless master node at a wireless device in a WBMS, where the first downlink indicates a second channel assigned to the wireless device. The method includes transmitting, in the first super frame, a synchronization frame from the wireless device to an unsynchronized wireless device on the second channel, where the synchronization frame indicates a third channel. The method also includes receiving, in the first super frame, the synchronization frame at the unsynchronized wireless device on the second channel. The method includes transmitting, on the third channel in a second super frame after the first super frame, an uplink from the unsynchronized wireless device to the wireless master node.

In accordance with at least one example of the description, a method includes determining, at a wireless master node, that a wireless device in a WBMS is out of synchronization. The method includes instructing, in a first super frame, a first synchronized wireless device in the WBMS to transmit a synchronization frame on a first channel. The method also includes receiving, in a second super frame after the first super frame, an uplink from an unsynchronized wireless device.

In accordance with at least one example of the description, a wireless master node in a WBMS includes a transceiver circuit and a processing circuit. The processing circuit is configured to determine that a wireless device in the WBMS is out of synchronization. The processing circuit is also configured to instruct, in a first super frame via the transceiver circuit, a first synchronized wireless device in the WBMS to transmit a synchronization frame on a first channel. The transceiver circuit is configured to receive, in a second super frame after the first super frame, an uplink from an unsynchronized wireless device.

### BRIEF DESCRIPTION OF THE DRAWINGS

FIG. 1 is a perspective view of an example system, such as an automotive vehicle, that includes a wireless battery management system (WBMS) in accordance with various examples.

FIG. 2A is a WBMS in accordance with various examples.

FIG. 2B is a WBMS in accordance with various examples.

FIGS. 3A and 3B show an example rejoin procedure for unsynchronized nodes.

FIG. 4 shows data and configuration channels in accordance with various examples.

FIGS. 5A and 5B show a node resynchronization mechanism in accordance with various examples.

FIGS. 6A, 6B, and 6C show a node resynchronization mechanism in accordance with various examples.

FIG. 7 is a countdown procedure for node resynchronization in accordance with various examples.

FIG. 8 is a flow diagram of a method for node resynchronization in a WBMS in accordance with various examples.

FIG. 9 is a flow diagram of a method for node resynchronization in a WBMS in accordance with various examples.

FIG. 10 is a flow diagram of a method for node resynchronization in a WBMS in accordance with various examples.

FIG. 11 is a flow diagram of a method for node resynchronization in a WBMS in accordance with various examples.

The same reference numbers or other reference designators are used in the drawings to designate the same or similar (functionally and/or structurally) features.

### DETAILED DESCRIPTION

Some electronic devices operate using batteries. For example, electric vehicles include multiple battery cells that provide power to those vehicles. Because battery cells in an electronic device can provide large amounts of power, and further because the power provided by the battery cells may be vital to the operation of the electronic device, the electronic device may include a system to manage the battery cells.

Battery management systems (BMSs) may manage the battery cells of an electronic device in various ways. For example, a BMS may monitor the health (e.g., voltage, current, temperature) of battery cells in an electronic device. Further, the BMS may control various battery cells to manage the quantity of power provided by the battery cells and where that power is directed within the electronic device. Generally, a BMS includes multiple components, such as multiple battery modules and a controller to manage the battery modules. Each battery module, in turn, may couple to multiple battery cells and include a battery monitor to monitor those battery cells. Thus, the battery cells coupled to a battery module provide power to the electronic device; the battery monitor in the battery module monitors the health and operation of the battery cells in that battery module; and the controller communicates with the battery monitor to ensure the battery module and its cells are operating properly. The controller may also communicate with the battery monitor to control the operation of the battery cells, such as to turn on, turn off, redirect, or otherwise balance the power provided by those battery cells.

BMSs may incorporate wireless technology to create a wireless battery management system (WBMS). For example, a primary network node contains or is coupled to a controller and a secondary network node contains a battery module that controls multiple battery cells. The primary and secondary network nodes (e.g., the main/master node and the end nodes) may communicate with each other wirelessly, for example using radio frequencies. In some protocols, a super frame (SF) is useful to facilitate wireless communications between the primary and secondary network nodes. In the SF, the primary network node first broadcasts a downlink communication (or packet) to multiple secondary network nodes. The secondary network nodes individually respond to the primary network node with uplink communications (or packets) in a serial manner. Additional example details of WBMSs can be found in commonly assigned U.S. patent application Ser. No. 17/828,895, entitled “Efficient Unicast Super Frame Communications,” filed on May 31, 2022, which is incorporated by reference in its entirety.

In a WBMS, nodes may occasionally become unsynchronized, where a secondary node (a wireless device, or WD) loses communication with the primary node (a wireless master, or WM). It may be desirable to resynchronize the unsynchronized WD quickly with minimal interruption to data service. The WD could become unsynchronized due to a power reset, wireless interference, collision between interrupts that cause a reset, loss of hopping sequence information, etc. The unsynchronized WDs no longer follow the channel hopping sequence, and cannot receive data. If a WD becomes unsynchronized, the entire WBMS network could be reset to restore synchronization. However, resetting the entire network can cause disruption, where the properly operating synchronized WDs undergo an unnecessary synchronization process. Resetting the entire network may also take many super frames before normal operation is restored, which leads to long disruptions of normal operation. In a wireless environment with high interference, frequent interruptions and network resets could occur.

In examples herein, a WM detects that one or more WDs are unsynchronized. After detecting the unsynchronized WDs, the WM selects one or more synchronized WDs and those selected synchronized WDs transmit “sync frames” on one of the configuration channels in selected uplink slots in a super frame. Each of the selected WDs transmit a sync frame in one or more uplink slots except their own uplink slot in a super frame. The sync frame specifies select timestamps and a data channel for data transmissions in a next super frame. The unsynchronized WDs listen on a configuration channel for the sync frames. The unsynchronized WDs receive the sync frames and use the information in the sync frame to synchronize timing and to switch to the specified data channel for the next super frame. In the next super frame, the unsynchronized WDs receive the next downlink (DL) from the WM, and are therefore synchronized again. The time to resynchronize the unsynchronized WDs is therefore one super frame in many examples. Also, the synchronized WDs continue to transmit their uplinks to the WM while the resynchronization process is occurring, thereby avoiding disruption of the operation of the WBMS except for the unsynchronized WDs.

In one example, the WM can implement a countdown process, where the selected synchronized WDs do not transmit the sync frames in the next super frame, but instead transmit the sync frames in a designated future super frame. In this example, the selected WDs can acknowledge to the WM that the WD received the sync frame instruction. The WM can also wait to check for synchronization status until the designated future super frame, rather than checking every super frame.

In the examples herein, enlisting the synchronized WDs to help with node resynchronization avoids service disruption of the WBMS. During the node resynchronization process, the WM can continue to send DLs to WDs, and the WDs that are synchronized can continue to respond to the WM in the appropriate time slots. Thus, it may be preferable for the WM to enlist one or more WDs to help with resynchronization by transmitting sync frames to reduce service disruption, rather than the WM transmitting the sync frames without help from any of the WDs. Additional example details of resynchronizing WDs can be found in commonly assigned U.S. patent application Ser. No. 17/977,906, entitled “Methods, Apparatus, and Articles of Manufacture to Improve One-Hop Extension in Wireless Battery Management Systems,” filed on Oct. 31, 2022, which is incorporated by reference in its entirety.

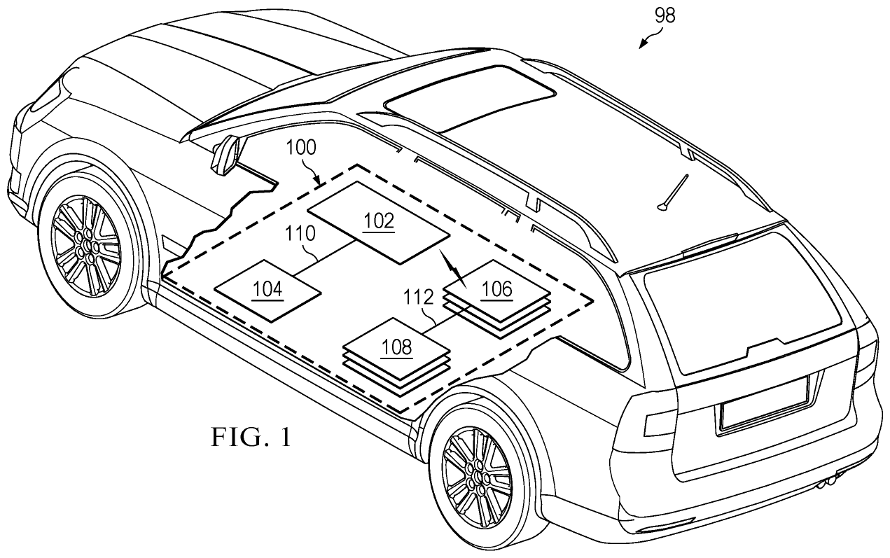

FIG. 1 is a perspective view of an example system 98, such as an automotive vehicle, that includes a WBMS 100, in accordance with various examples herein. Although system 98 is described in the automotive context, the techniques of this disclosure may be implemented in other systems such as home automation, industrial automation, and wireless sensor networks. In some examples, the system 98 is any system that may include a WBMS 100 to supply power to one or more components of the system 98. As shown, WBMS 100 includes a primary network node 102, a battery controller 104, a plurality of secondary network nodes 106, and a plurality of battery cells 108. In one example, the primary network node 102 may be a WM, and the secondary network nodes 106 may be wireless heads (WHs) and WDs arranged in a hierarchical structure, with the WDs arranged in sub-clusters and each sub-cluster having a WH to manage its respective WDs. Additional example details of a hierarchical structure in a WBMS can be found in commonly assigned U.S. patent application Ser. No. 18/345,636, entitled “Hierarchical Wireless Battery Management System” filed on Jun. 30, 2023, which is incorporated by reference in its entirety. Although this disclosure describes communication techniques primarily in the context of wireless systems, these techniques may also be useful for wired systems (e.g., where the connection between nodes 102 and 106 is wired).

In an example, the primary network node 102 is coupled to the battery controller 104 using a first wired connection 110. In an example, the first wired connection 110 between the primary network node 102 and the battery controller 104 is a universal asynchronous receiver/transmitter (UART), inter-integrated circuit (I2C), or the like. The secondary network nodes 106 are wirelessly coupled to the primary network node 102 (e.g., the WM). The WDs in the secondary network nodes are coupled to the battery cells 108 using a second wired connection 112. Although FIG. 1 shows a single primary network node 102 and a single battery controller 104, other example network architectures having multiple primary/main nodes may be used to implement the techniques of this disclosure. Additional example details of multiple main nodes in a WBMS can be found in commonly assigned U.S. patent application Ser. No. 17/823,138, entitled “Multiple Primary Nodes for Wireless Battery Management System Robustness,” filed on Aug. 30, 2022, which is incorporated by reference in its entirety.

In an example, WBMS 100 provides wireless radio frequency (RF) communication between the primary network node 102 and the secondary network nodes 106 (and between the WHs and the WDs, in a hierarchical structure). In an example, the wireless RF communication uses the license-free 2.4 gigahertz (GHz) industrial, scientific, and medical (ISM) band from 2.4 GHz to 2.483 GHz, which is compliant with BLUETOOTH special interest group (SIG). In examples, WBMS 100 uses 2 megabits per second (Mbps) BLUETOOTH low energy (BLE) across the physical layer (PHY). The Open Systems Interconnection (OSI) model includes the PHY as a layer used for communicating raw bits over a physical medium. In this case, the PHY is free space, which WBMS 100 uses to wirelessly communicate between the primary network node 102 and the WHs of the secondary network nodes 106. In an example, the transmission power of WBMS 100 is less than or equal to 10 decibel-milliwatts (dBm).

In an example, the wireless RF communication between the primary network node 102 and the secondary network nodes 106 utilizes frequency hopping and time slotted allocations to transmit and receive data across SFs. An SF, also referred to as a super frame interval, is a time interval including time and frequency allocations for data exchanges between the primary network node 102 and the secondary network nodes 106, including interframe spacing between these allocations. Frequency hopping includes transmitting RF signals by rapidly changing the transmission frequency among many distinct frequencies occupying a spectral band. In an example, frequency hopping occurs based on a linear shift-back register and a master identification (ID) of the primary network node 102. The linear shift-back register uses linear bit rotation to indicate a pattern of frequencies on which the primary network node 102 and the secondary network nodes 106 will communicate. Time slotted allocations are time slots that are assigned either to the primary network node 102 or one or more of the secondary network nodes 106 for transmitting to either one or more of the secondary network nodes 106 or the primary network node 102. The time slotted allocations occur in a half-duplex mode, as both the primary network node 102 and the secondary network nodes 106 switch between transmit and receive modes according to the temporal moment specified in scan/pairing frames of exchanged data for downlink (DL)/uplink (UL) durations.

In an example, the WBMS 100 uses frequency division multiple access (FDMA) and changes the frequency at which frames are transmitted between the primary network node 102 and the respective secondary network nodes 106 to increase robustness against interference. In an example, the WBMS 100 uses frequency hopping tables, black listing of frequencies, and configuration channels to mitigate interference with other wireless networks. Frequency hopping occurs on a per SF basis, where during the SF, time slotted allocations are used for frame exchange. Black listing is suspending the use of frequency channels that may be susceptible to interference. Configuration channels may be used for scanning, pairing, and negotiating communication between the primary network node 102 and the secondary network nodes 106.

In an example, the wireless RF communication between the primary network node 102 and the secondary network nodes 106 uses 40 channels, where a subset of the 40 channels (e.g., channels 37, 38, and 39) is used for system configuration and the remaining 37 channels are used to exchange data. In an example, a single channel may be used as a configuration channel.

In an example, WBMS 100 supports periodic and a-periodic data exchanges from the secondary network nodes 106 to the primary network node 102 using wireless RF communication. The primary network node 102 and the secondary network nodes 106 use a common data format structure for both periodic and a-periodic data exchanges. Periodic data exchange occurs based on a repetitive interval, while a-periodic data exchange does not occur based on a repetitive interval. The data format is a description of rules that the data populating a file will follow. Generally, the more thorough the description of the data format, the easier it is for validation rules to be written on both the sending and receiving sides of the WBMS 100.

In an example, the primary network node 102 scans the network to obtain a master ID and discover the secondary network nodes 106. The primary network node 102 scans the network by transmitting a management frame to coordinate medium access, wakeup schedules, and clock synchronization within the secondary network nodes 106. The primary network node 102 also uses the management frame to learn about the secondary network nodes 106 in the network. Initially, the primary network node 102 performs a passive scan to obtain (or check for) a master ID value in use by other nodes and/or devices. The primary network node 102 then selects a master ID that is different from the master IDs used by other nodes and/or devices.

In an example, after the primary network node 102 has selected a master ID, the primary network node 102 transmits a scan request frame in every SF period as long as there are unconnected secondary network nodes 106 from the primary network node 102. In an example, the primary network node 102 is programmed with the total number of the secondary network nodes 106 to be connected to the primary network node 102. After all the secondary network nodes 106 are connected and confirmed, the primary network node 102 will not transmit any more scan requests. The scan request frames include information about the structure of the SF and the frame formatting of the DL and UL slots.

For the primary network node 102 to scan for the secondary network nodes 106, the primary network node 102 enters a scan state. In this state, the primary network node 102 transmits a scan request frame in every SF period. The secondary network nodes 106 reply to the primary network node 102 with a scan response and await a pairing request frame from the primary network node 102. After the secondary network nodes 106 receive the pairing request, the secondary network nodes 106 respond within the same SF in the frequency slot assigned by the primary network node 102. In examples, this exchange occurs in the configuration channels. No data exchanges occur in this state. Additional example details of establishing a communication channel can be found in commonly assigned U.S. Patent Application Publication No. 2022/0332213, entitled “Wireless Protocol for Battery Management,” filed on Apr. 16, 2021; and U.S. Patent Application Publication No. 2023/0051689, entitled “Wireless Battery Management System Setup,” filed on Aug. 11, 2021, each of which is incorporated by reference in its entirety.

In an example, transmission cycles or SFs depend on the number of secondary network nodes 106 and/or battery cells 108 in the network. The primary network node 102 determines the SF interval based on the number of secondary network nodes 106. Given a number of secondary network nodes 106, the primary network node 102 estimates the number of DL slots usable to transmit the packets to the secondary network nodes 106. Accordingly, the total number of slots in the communication time interval becomes the following:

$$Total\_slots = nr\_of \_WD + nr\_DL \_slots ,$$

where nr_of_WD is the number of secondary network devices and nr_DL_slots is the number of DL slots available to the secondary network devices.

WBMS 100 manages the battery cells 108 using the primary network node 102, the battery controller 104, and the secondary network nodes 106. The primary network node 102 and the secondary network nodes 106 communicate with each other about the state of the battery cells 108. The primary network node 102 and the secondary network nodes 106 may communicate with or among each other using various protocol formats. For example, the primary network node 102 and the secondary network nodes 106 use a DL protocol format and a UL protocol format, where each of the DL protocol format and the UL protocol format includes a frame control field to communicate battery management information. When the battery cells 108 notify the secondary network nodes 106 of a condition, the secondary network nodes 106 communicate to the primary network node 102 that the condition is present. The primary network node 102 receives the notification of the condition from the secondary network nodes 106 and alerts the battery controller 104 of the condition. The battery controller 104 determines a proper reaction to the condition and sends an instruction to the primary network node 102. The primary network node 102 transmits the instruction to the secondary network nodes 106. The secondary network nodes 106 receive the instruction to manage the battery cells 108 in response to the condition. The secondary network nodes 106 manage the battery cells 108 in response to the condition.

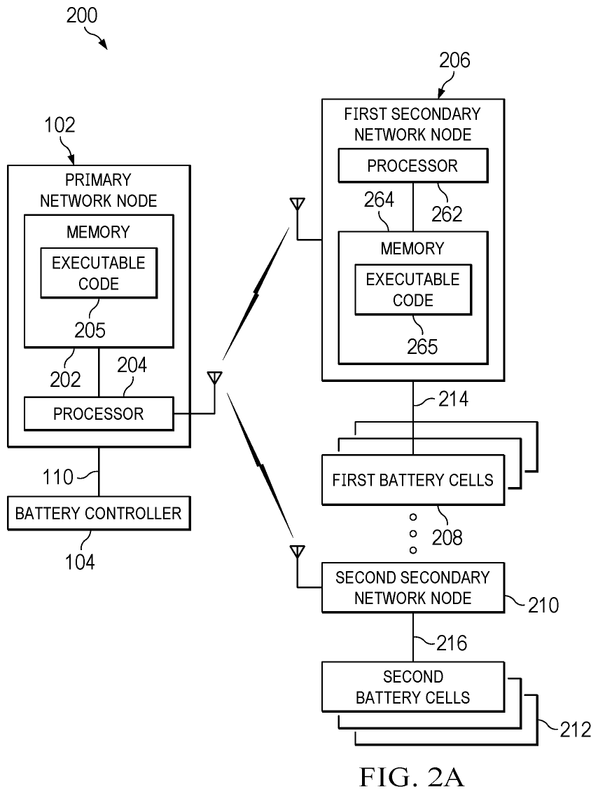

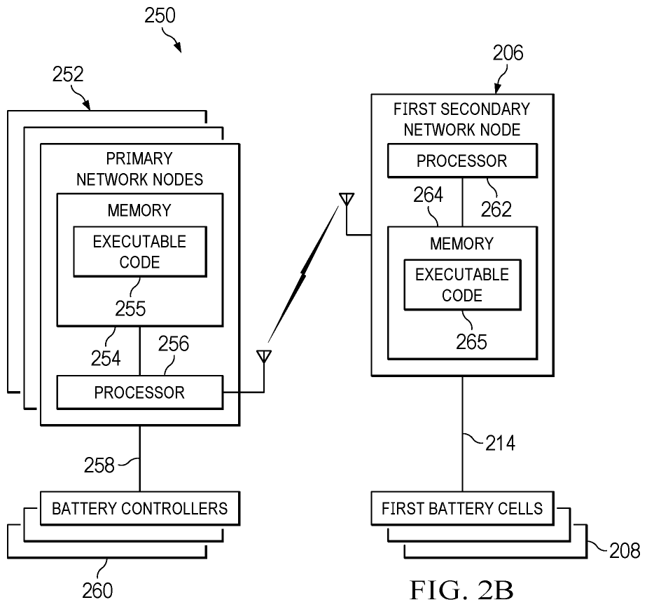

FIG. 2A illustrates an example WBMS 200. WBMS 200 is an example of WBMS 100 described above. As shown, WBMS 200 includes the primary network node 102, the battery controller 104, a memory 202, a processor 204, a first secondary network node 206, a first plurality of battery cells 208, a second secondary network node 210, and a second plurality of battery cells 212. Additional secondary network nodes 206, 210 may be included, although they are not expressly shown. The primary network node 102 includes the memory 202 and the processor 204 that is configured to execute code 205 stored on the memory 202 to perform one or more of the actions attributed herein to the primary network node 102. In an example, a portion of the memory 202 may be non-transitory and a portion of the memory 202 may be transitory. The secondary network nodes 206, 210 also may include processors and memory. For example, as shown, the first secondary network node 206 includes a processor 262 coupled to a memory 264 storing executable code 265 that is executable by the processor 262 to perform one or more of the actions attributed herein to the first secondary network node 206. A processor as described herein may include any suitable processor or combination of processors. For example, a processor, such as processor 204 or 262, may be a central processing unit (CPU), digital signal processor (DSP), a microcontroller unit (MCU), a DSP+MCU processor, a field programmable gate array (FPGA), processing circuitry, or an application specific integrated circuit (ASIC). A primary network node 102 and a secondary network node 106 may also include transmitter and receiver circuits or circuitry (e.g., a transceiver circuit) configured to perform the operations described herein. The transmitter and receiver circuitry may include any suitable hardware or software for performing the operations described herein.

The primary network node 102 is coupled to the battery controller 104 using the first wired connection 110 and is wirelessly coupled to each of the secondary network nodes 206, 210. The first secondary network node 206 is coupled to the first plurality of battery cells 208 using a third wired connection 214 and wirelessly coupled to the primary network node 102. The second secondary network node 210 is coupled to the second plurality of battery cells 212 using a fourth wired connection 216 and wirelessly coupled to the primary network node 102. FIG. 2A does not limit the number of secondary network nodes in the WBMS 200; rather, the naming convention indicates that each of the secondary network nodes is coupled to a plurality of battery cells.

In an example, the primary network node 102 is wirelessly coupled to at least eight secondary network nodes 206, 210. In an example, each of the secondary network nodes 206, 210 can be coupled to at least sixteen battery cells using a wired connection. In examples, the WBMS 200 includes one primary network node. In other examples, the WBMS 200 includes multiple primary network nodes, with each network having its own hierarchical structure.

WBMS 200 manages the first plurality of battery cells 208 and the second plurality of battery cells 212 using the primary network node 102, the battery controller 104, the memory 202, the processor 204, the first secondary network node 206, and the second secondary network node 210. Instructions in the memory 202 cause the processor 204 to instruct the primary network node 102 to wirelessly communicate with the first secondary network node 206 and the second secondary network node 210 about the state of the first plurality of battery cells 208 and the second plurality of battery cells 212. The primary network node 102 and the secondary network nodes 206, 210 communicate using various protocol formats. For example, the primary network node 102 and the secondary network nodes 206, 210 use a DL protocol format and a UL protocol format, where each of the DL protocol format and the UL protocol format includes a frame control field to communicate battery management information. When the first plurality of battery cells 208 notify the first secondary network node 206 of a condition, the first secondary network node 206 communicates with the primary network node 102 that the condition is present. The primary network node 102 receives the notification of the condition from the first secondary network node 206 and alerts the battery controller 104 of the condition. The battery controller 104 determines a proper reaction to the condition and sends an instruction to the primary network node 102. The primary network node 102 transmits the instruction to the first secondary network node 206. The first secondary network node 206 receives the instruction to manage the first plurality of battery cells 208 in response to the condition of the first plurality of battery cells 208. The first secondary network node 206 manages the first plurality of battery cells 208 in response to the condition. A similar process may apply to the second secondary network node 210 when a condition is present in the second plurality of battery cells 212. If the WBMS uses a hierarchical structure as described above, the WM communicates with the WHs, and the WHs communicate with the respective WDs and then relay the responses from the WDs back to the WM.

FIG. 2B illustrates an example WBMS 250. WBMS 250 is an example of WBMS 100 described above. As shown, WBMS 250 includes the first secondary network node 206, the first plurality of battery cells 208, a plurality of primary network nodes 252, a memory 254, a processor 256, a first wired connection 258, and a plurality of battery controllers 260. The plurality of primary network nodes 252 includes the memory 254 and the processor 256. In an example, a portion of the memory 254 may be non-transitory and a portion of the memory 254 may be transitory. In examples, the memory 254 includes executable code 255 which, when executed by the processor 256, causes the processor 256 to perform the actions attributed herein to the plurality of primary network nodes 252.

The plurality of primary network nodes 252 are coupled to the plurality of battery controllers 260 using the first wired connection 258 and are wirelessly coupled to the first secondary network node 206. The first secondary network node 206 is coupled to the first plurality of battery cells 208 using the third wired connection 214 and wirelessly coupled to the plurality of primary network nodes 252. As shown in FIG. 2B, the first secondary network node 206 may include a processor and memory (e.g., processor 262 and memory 264). FIG. 2B does not limit the number of secondary network nodes in the WBMS 250. In an example, each of the plurality of primary network nodes 252 is wirelessly coupled to at least eight secondary network nodes. In an example, the first secondary network node 206 can be coupled to at least sixteen battery cells using the fourth wired connection 216.

WBMS 250 manages the first plurality of battery cells 208 using the plurality of primary network nodes 252, the plurality of battery controllers 260, the memory 254, the processor 256, and the first secondary network node 206. Instructions in the memory 254 cause the processor 256 to instruct the plurality of primary network nodes 252 to wirelessly communicate with the first secondary network node 206 about the state of the first plurality of battery cells 208. The plurality of primary network nodes 252 and the first secondary network node 206 communicate using various protocol formats. For example, the plurality of primary network nodes 252 and the first secondary network node 206 use a DL protocol format and a UL protocol format, where each of the DL protocol format and the UL protocol format includes a frame control field to communicate battery management information. When the first plurality of battery cells 208 notify the first secondary network node 206 of a condition, the first secondary network node 206 communicates with the plurality of primary network nodes 252 that the condition is present. The plurality of primary network nodes 252 receives the notification of the condition from the first secondary network node 206 and alerts the plurality of battery controllers 260 of the condition. The plurality of battery controllers 260 determines a proper reaction to the condition and sends an instruction to the plurality of primary network nodes 252. The plurality of primary network nodes 252 transmits the instruction to the first secondary network node 206. The first secondary network node 206 receives the instruction to manage the first plurality of battery cells 208 in response to the condition of the first plurality of battery cells 208. The first secondary network node 206 manages the first plurality of battery cells 208 in response to the condition.

In an example, the first secondary network node 206 communicates with a first primary network node of the plurality of primary network nodes 252 based on instructions from a master controller (not shown). The first secondary network node 206 can transition communication from the first primary network node to a second primary network node of the plurality of primary network nodes 252. The first primary network node and the second primary network node communicate with each other to coordinate transferring the active connections of the first secondary network node 206 from the first primary network node to the second primary network node. In an example, the first primary network node communicates with the first secondary network node 206 and the second primary network node monitors a status of the first primary network node. The status can indicate whether the first primary network node has power and is operating within normal operating conditions. The first primary network node provides a clock signal to the second primary network node to synchronize communication. The first primary network node and the second primary network node select different frequencies to communicate with the first secondary network node 206. Selecting different frequencies allows the plurality of primary network nodes 252 to minimize interference when communicating to the first secondary network node 206. For example, if the first primary network node were to lose power, or if the status of the first primary network node were to fall out of normal operating conditions, then the second primary network node can connect to the first secondary network node 206 to supplement communication until the first primary network node can operate normally again.

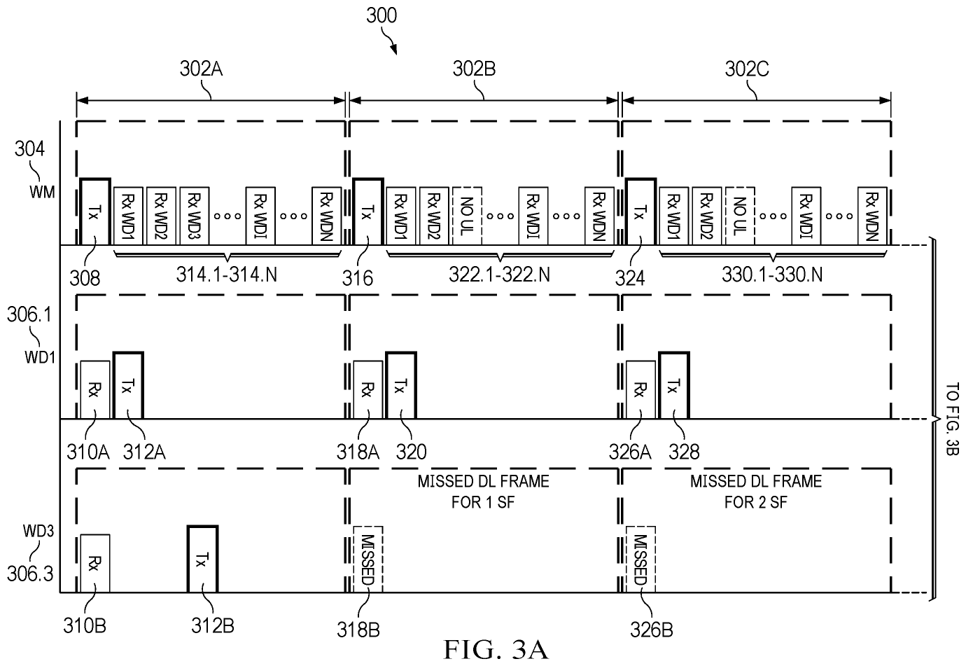

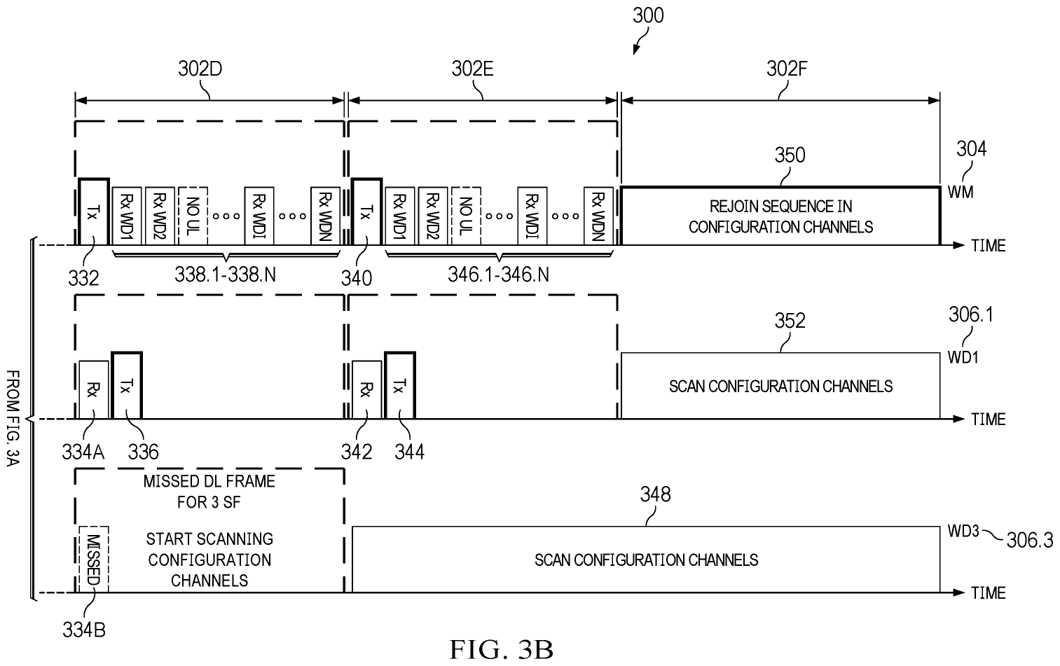

FIGS. 3A and 3B show an example rejoin procedure 300 for unsynchronized nodes. Rejoin procedure 300 includes a number of example super frames 302 (e.g., 302A, 302B, 302C in FIG. 3A, and 302D, 302E, and 302F in FIG. 3B). Super frames 302 include example uplinks (ULs) and downlinks (DLs) for a WM 304 and WDs 306.1 and 306.3. In this example, WM 304 may be a primary network node 102 as described above. WD1 306.1 and WD3 306.3 may be secondary network nodes 106 as described above. In this example, two WDs 306 are shown, but any number of WDs 306 may be present in other examples. The super frames 302 include various ULs and DLs 308 to 346, which may be labeled Rx and Tx herein. These Tx's and Rx's represent the communications between the devices in an example WBMS (e.g., WBMS 100). The details of each of the Tx's and Rx's 308 to 346 are described below.

Rejoin procedure 300 is an example rejoin procedure where WD1 306.1 remains synchronized with WM 304, and WD3 306.3 becomes unsynchronized. Therefore, a rejoin procedure is performed to synchronize WD3 306.3. In SF 302A in FIG. 3A, WM 304 sends Tx 308 on a data channel to each WD 306. Here, WD1 306.1 receives Rx 310A, and WD3 306.3 receives Rx 310B. Tx 308 may contain instructions for the WDs 306 to provide information, such as a status of the battery cells 108 coupled to the respective WD 306. Responsive to receiving the Rx 310A, WD1 306.1 sends a Tx 312A back to WM 304 in a time slot of SF 302A assigned to WD1 306.1. Responsive to receiving the Rx 310B, WD3 306.3 sends a Tx 312B back to WM 304 in a time slot of SF 302A assigned to WD3 306.3. The ULs received by WM 304 from each WD 306 are shown as Rx 314.1 to Rx 314.N, where the WBMS 100 includes N WDs 306.

SF 302B begins similarly to SF 302A. In SF 302B, WM 304 sends Tx 316 on a data channel to each WD 306. Here, WD1 306.1 receives Rx 318A. However, in this example, WD3 306.3 has become unsynchronized in SF 302B, and therefore WD3 306.3 misses its Rx (shown as missed Rx 318B). Therefore, WD3 306.3 has missed a DL frame for one SF.

Responsive to receiving the Rx 318A in SF 302B, WD1 306.1 sends a Tx 320 back to WM 304 in a time slot of SF 302B assigned to WD1 306.1. The ULs received by WM 304 from each WD 306 are shown as Rx 322.1 to Rx 322.N. As shown in SF 302B, WD3 306.3 did not provide an UL in its time slot to WM 304, which is shown as a missed Rx 322 (“No UL”) in SF 302B. WM 304 tracks the missed ULs from the various WDs 306 in one example to determine if a rejoin procedure should be initiated.

SF 302C also begins similarly to SF 302A. In SF 302C, WM 304 sends Tx 324 on a data channel to each WD 306. Here, WD1 306.1 receives Rx 326A. In SF 302C, WD3 306.3 is still unsynchronized, and therefore WD3 306.3 misses its Rx (shown as missed Rx 326B). Therefore, WD3 306.3 has missed a DL frame for two SFs 302 (e.g., SF 302B and 302C).

Responsive to receiving the Rx 326A in SF 302C, WD1 306.1 sends a Tx 328 back to WM 304 in a time slot of SF 302C assigned to WD1 306.1. The ULs received by WM 304 from each WD 306 in SF 302C are shown as Rx 330.1 to Rx 330.N. As shown in SF 302C, WD3 306.3 did not provide an UL in its time slot to WM 304, which is shown as another missed Rx 330 (“No UL”) in SF 302C. WM 304 tracks that WD3 306.3 has missed an UL for two consecutive SFs 302.

In FIG. 3B, during SF 302D, WM 304 sends Tx 332 on a data channel to each WD 306. Here, WD1 306.1 receives Rx 334A. In SF 302D, WD3 306.3 is still unsynchronized, and therefore WD3 306.3 misses its Rx (shown as missed Rx 334B). Therefore, WD3 306.3 has missed a DL frame for three SFs 302. In this example, the WDs 306 are programmed to begin scanning configuration channels if a DL is missed for three consecutive SFs 302. In other examples, a different number of missed SFs 302 may be missed before the WD 306 scans the configuration channels.

Responsive to receiving the Rx 334A in SF 302D, WD1 306.1 sends a Tx 336 back to WM 304 in a time slot of SF 302D assigned to WD1 306.1. The ULs received by WM 304 from each WD 306 in SF 302D are shown as Rx 338.1 to Rx 338.N. As shown in SF 302D, WD3 306.3 did not provide an UL in its time slot to WM 304, which is shown as another missed Rx 338 (“No UL”) in SF 302D. WM 304 tracks that WD3 306.3 has missed an UL for three consecutive SFs 302.

In SF 302E, WM 304 has determined that one or more WDs 306 (in this case, WD3 306.3), has missed three SFs 302. Responsive to this determination, WM 304 instructs all WDs 306 to switch to configuration channels for a rejoin sequence. WM 304 sends Tx 340 to each WD 306 on a data channel. Tx 340 includes the instruction for the WDs 306 to switch to a configuration channel. WD1 306.1 receives Rx 342 in SF 302E, and sends Tx 344 to WM 304. WM 304 receives ULs (Rx) from each WD 306, shown as Rx 346.1 to Rx 346.N in SF 302E. SF 302E shows that WM 304 again does not receive an Rx 346 from WD3 306.3.

In SF 302E, WD3 306.3 begins scanning config channels with procedure 348. In SF 302F, WM 304 begins a rejoin sequence 350 using the configuration channels. WD1 306.1 also scans configuration channels in procedure 352. In this example, a rejoin sequence 350 is performed for each WD 306, even the WDs 306 that are still synchronized (such as WD1 306.1).

By performing the rejoin sequence 350 for each WD 306, the synchronized WDs 306 have their operation disrupted for the rejoin sequence 350 by performing procedure 352. During the rejoin sequence 350, the WDs 306 do not exchange data with WM 304. Therefore, the normal operation of the WDs 306 may be disrupted by the rejoin sequence 350. If a large number of WDs are present in a WBMS 100, and the system includes substantial wireless interference, rejoin sequences 350 may be performed frequently, which disrupts the normal operation of the WBMS 100. In other words, the rejoin sequence 350, without any help from the synchronized WDs, may be slow and disruptive to the operation of WBMS 100. In other examples described below, a node resynchronization mechanism is provided that rejoins unsynchronized WDs 306 but does not disrupt the operation of the synchronized WDs 306.

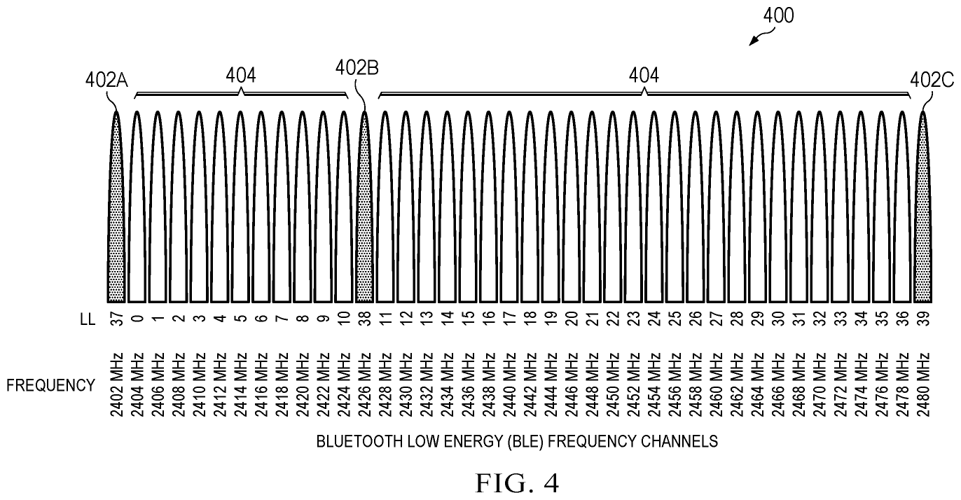

FIG. 4 shows data and configuration channels 400 in accordance with various examples herein. The configuration channels 400 may be Bluetooth Low Energy (BLE) frequency channels in some examples, with the example frequencies shown in FIG. 4. This example includes three configuration or advertising channels (402A, 402B, and 402C), which are channels 37, 38, and 39. Channels 404 are the data channels, and includes channels 0 to 36, for a total of 37 data channels. As described in further detail below, the nodes in a network may be configured to communicate on channels 404 using frequency hopping. Additional example details of frequency hopping in a WBMS can be found in commonly assigned U.S. patent application Ser. No. 17/898,614, entitled “Adaptive Frequency Hopping in a Wireless Battery Management System,” filed on Aug. 30, 2022, which is incorporated by reference in its entirety.

As shown in FIG. 4, the three configuration channels are adjacent to certain data channels. For example, configuration channel 38 is in an adjacent frequency band to the frequency band for data channels 10 and 11. Channels that are adjacent or close in frequency bands may interfere with one another. As described below, configuration and data channels may be selected using adjacency rules to reduce the chances of interference amongst the assigned channels. The adjacency rule may consider the transmission power spectrum characteristics, the center frequency separation, signal to noise ratio requirements, etc., for selecting and assigning channels.

In examples herein, a node resynchronization mechanism includes sending synchronization frames (e.g., “sync frames”) from synchronized WDs that can be received by unsynchronized WDs. The sync frame specifies select timestamps and a data channel for data transmissions in a next super frame. The unsynchronized WDs listen on a configuration channel for the sync frames. The unsynchronized WDs receive the sync frames and use the information in the sync frame to synchronize timing and to switch to the specified data channel for the next super frame. The synchronized WDs continue to transmit their uplinks to the WM while the resynchronization process is occurring, thereby avoiding disruption of the operation of the WBMS.

In an example operation, a WM makes a list of synchronized and unsynchronized WDs based on a previous superframe. It may take multiple SFs for an unsynchronized node to be confirmed. If there are unsynchronized WDs, the WM selects three synchronized WDs. The selected synchronized WDs may be selected randomly or using any suitable algorithm. The WM then creates a schedule of resynchronization frames (sync frames) for the current SF before transmitting its normal DL to the synchronized WDs. A configuration channel is assigned to each selected WD by the WM.

Next, the WM checks for adjacent channel interference using a predetermined adjacency rule. If the current data channel used for transmitting data between the WM and the WDs is adjacent to the assigned configuration channels 1, 2, or 3, then the WD corresponding to the adjacent configuration channel is removed from the schedule created by the WM. The adjacent channels could result in interference. As described above, the adjacency rule can consider the transmission power spectrum characteristics, center frequency separation, and signal to noise ratio (SNR) requirements. A rule such as “must be separated by at least 2 channels” may be used in some examples.

The WM then transmits the schedule with the configuration channel assignments and sync frame information in the next DL frame. The selected synchronized WDs receive the DL frame from the WM. The selected WDs prepare sync frames to transmit in every UL slot except that WDs own UL slot. The WD transmits to the WM in its own UL slot. The sync frames are transmitted on the assigned configuration channel by each selected WD. The sync frames may include the current timestamp, the timestamp of the next expected DL frame, and the data channel of the next expected DL frame. The unsynchronized WDs can then uniquely identify the WBMS network in time and frequency space, and are able to synchronize and receive their next DL reception from the WM. The WM can then receive UL frame receptions from each WD including previously unsynchronized WDs in the next SF and again monitor for missed ULs from the WDs.

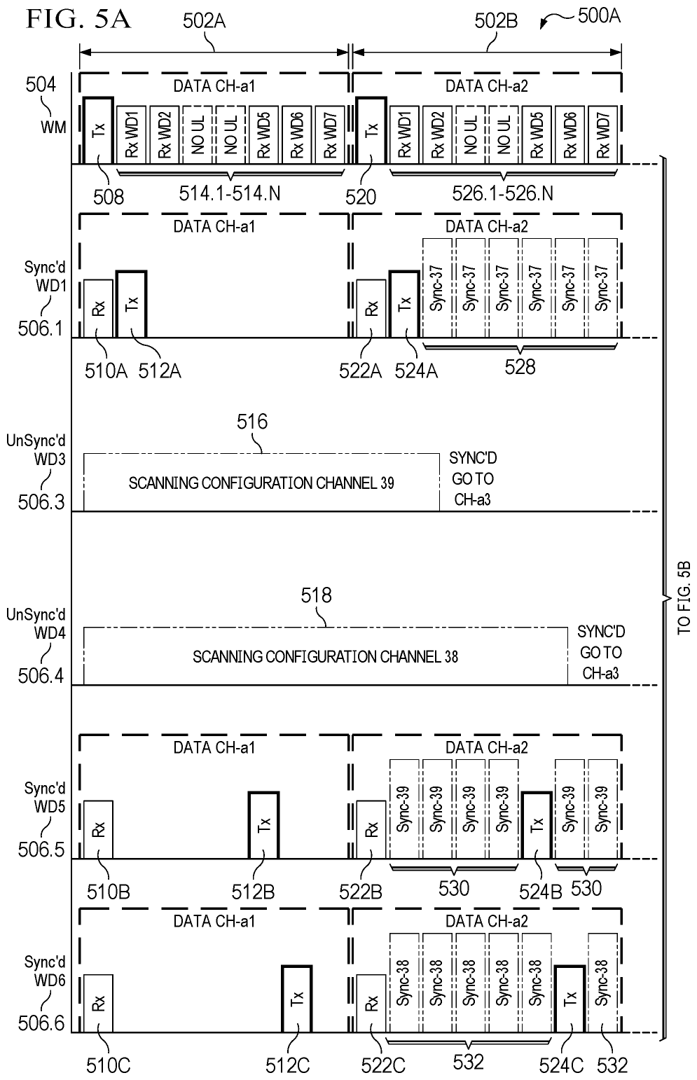

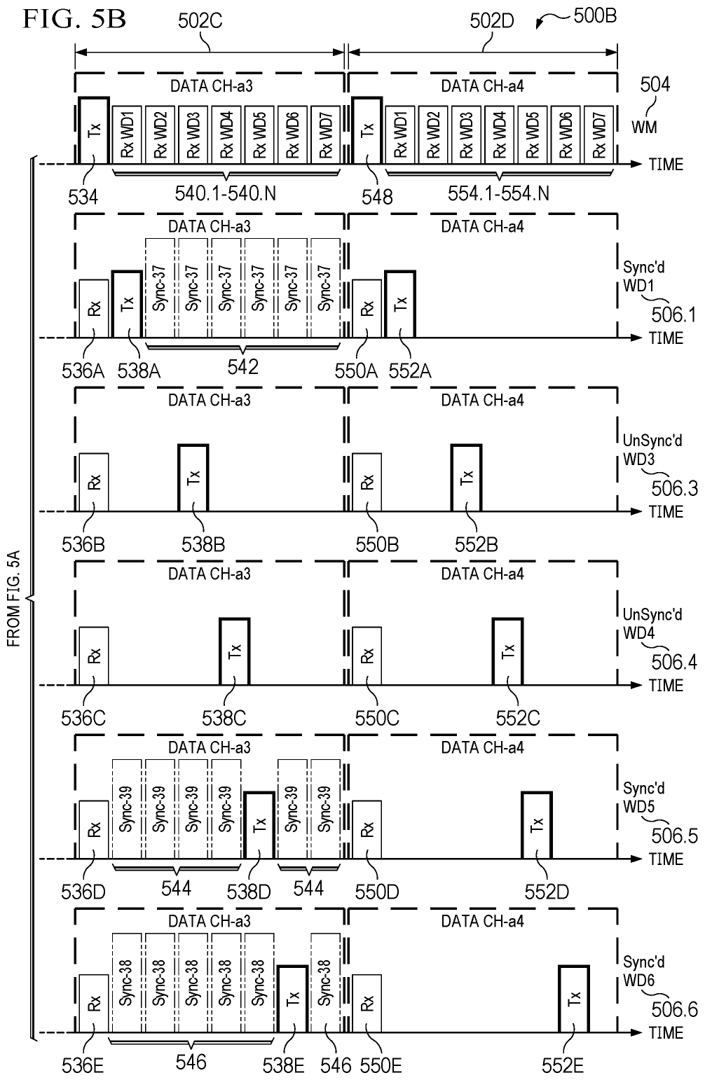

FIGS. 5A and 5B show a node resynchronization mechanism in accordance with various examples herein. FIG. 5A shows a super frame structure 500A, and FIG. 5B shows a continuation of the super frame structure 500B. The super frame structures 500A and 500B includes ULs and DLs for various devices that are shown on the left side of FIGS. 5A and 5B (WM 504, WD1 506.1, WD3 506.3, WD4 506.4, WD5 506.5, and WD6 506.6). The ULs and DLs shown in each row are the links either sent or received by the particular device listed on the left. For example, the top row of FIGS. 5A and 5B show the ULs and DLs associated with WM 504, either sent by WM 504 or received by WM 504. Likewise, the last rows of FIGS. 5A and 5B show the ULs and DLs associated with WD6 506.6, either sent by WD6 506.6 or received by WD6 506.6. In an example, WM 504 may be a primary network node 102 as described above, and the WDs 506 may be secondary network nodes 106.

Super frame structure 500A includes a first SF 502A and a second SF 502B. Super frame structure 500B includes a third SF 502C and a fourth SF 502D. Super frame structures 500A and 500B includes various ULs and DLs 508 to 554. These ULs and DLs represent the communications between the devices in an example WBMS (e.g., WBMS 100). The details of each of the ULs and DLs 508 to 554 are described below.

Super frame structures 500A and 500B also show the channels that the devices in WBMS 100 are using for communication. The channels may include both data channels and configuration channels. The particular ULs and DLs that are transmitted on each channel are described below.

FIGS. 5A and 5B show one example node resynchronization process using super frame structures 500A and 500B. In the first SF 502A in FIG. 5A, WM 504 sends Tx 508 to the WDs 506 on a data channel (in this example, data channel al). Here, WD1 506.1 receives Rx 510A, WD5 506.5 receives Rx 510B, and WD6 506.6 receives Rx 510C. Tx 508 may contain instructions for the WDs 506 to provide information, such as a status of the battery cells 108 coupled to the respective WD 506. Responsive to receiving the Rx 510A, WD1 506.1 sends a Tx 512A back to WM 504 in a time slot of SF 502A assigned to WD1 506.1. Responsive to receiving the Rx 510B, WD5 506.5 sends a Tx 512B back to WM 504 in a time slot of SF 502A assigned to WD5 506.5. Responsive to receiving the Rx 510C, WD6 506.6 sends a Tx 512C back to WM 504 in a time slot of SF 502A assigned to WD6 506.6. The ULs received by WM 504 from each WD 506 are shown as Rx 514.1 to Rx 514.N, where the WBMS 100 includes N WDs 506 (N is 7 in this example).

In this example, WD3 506.3 and WD4 506.4 are unsynchronized. In SFs prior to SF 502A (not shown in FIG. 5A), WD3 506.3 and WD4 506.4 each determined that they had missed a certain number of DLs from WM 504. Responsive to this determination, WD3 506.3 and WD4 506.4 began scanning configuration channels in SF 502A. WD3 506.3 is scanning configuration channel 39 (process 516), and WD4 506.4 is scanning configuration channel 38 (process 518). The unsynchronized WDs 506 may scan any configuration channel responsive to determining that they are unsynchronized. The configuration channel to scan may be programmed, selected randomly, or selected with any suitable algorithm.

SF 502A shows the ULs received by WM 504 from the WDs 506 (Rx 514.1 to Rx 514.N). In this example, the WBMS 100 has seven WDs 506, but any number may be present in other examples. WD2 and WD7 are not shown in FIG. 5A and 5B for simplicity. WM 504 receives ULs from WDs 1, 2, 5, 6, and 7 in this example. The ULs from WD3 506.3 and WD4 506.4 are shown as missing UL (“No UL”) in FIG. 5A. As described above, the WM 504 may have also missed these ULs from WD3 506.3 and WD4 506.4 in SFs prior to SF 502A. Therefore, responsive to missing these ULs in SF 502A, WM 504 determines that a resynchronization process should begin in SF 502B.

For the resynchronization process, WM 504 makes a list of synchronized and unsynchronized WDs 506 based one or more a previous superframes (such as SF 502A in this example). In this example, WM 504 selects three synchronized WDs 506. A different number of WDs 506 may be selected in other examples depending on the number of configuration channels available, channel adjacency rule and other pertinent factors. WM 504 then creates a schedule (e.g., a table) of resynchronization frames (sync frames) for the current SF 502B before transmitting its normal DL to the synchronized WDs 506. A configuration channel is assigned to each selected WD 506 by the WM 504.

In this example, WM 504 selects WD1 506.1, WD5 506.5, and WD6 506.6 to send sync frames to the unsynchronized WDs 506. WM 504 assigns a configuration channel to each selected WD 506. In this example, the configuration channels are channels 37, 38, and 39. In SF 502B, WM 504 sends Tx 520 to the WDs 506. Tx 520 includes the sync frame information that WD1 506.1. WD5 506.5, and WD6 506.6 will send to the unsynchronized WDs 506. Tx 520 may also include the normal operating instructions for the WBMS 100, so the synchronized WDs 506 can continue to send their data to WM 504. In this example, Tx 520 is sent on data channel a2. WD1 506.1 receives Rx 522A, WD5 506.5 receives Rx 522B, and WD6 506.6 receives Rx 522C.

Responsive to receiving the Rx 522A, WD1 506.1 sends a Tx 524A back to WM 504 in a time slot of SF 502B assigned to WD1 506.1. Responsive to receiving the Rx 522B, WD5 506.5 sends a Tx 524B back to WM 504 in a time slot of SF 502B assigned to WD5 506.5. Responsive to receiving the Rx 522C, WD6 506.6 sends a Tx 524C back to WM 504 in a time slot of SF 502B assigned to WD6 506.6. The ULs received by WM 504 from each WD 506 are shown as Rx 526.1 to Rx 526.N. Once again, the ULs from WD3 506.3 and WD4 506.4 are missing in SF 502B.

In the node resynchronization process described herein, the selected WDs 506 transmit multiple sync frames on the configuration channels in their otherwise open time slots in SF 502B. For example, WD1 506.1 was assigned configuration channel 37 by WM 504. WD1 506.1 sends sync frames 528 on configuration channel 37 (shown in FIG. 5A as Sync-37) in the time slots of SF 502B that are not used by WD1 506.1 to communicate with WM 504. WD5 506.5 sends sync frames 530 on configuration channel 39 (shown in FIG. 5A as Sync-39) in the time slots of SF 502B that are not used by WD5 506.5 to communicate with WM 504. WD6 506.6 sends sync frames 532 on configuration channel 38 (shown in FIG. 5A as Sync-38) in the time slots of SF 502B that are not used by WD5 506.5 to communicate with WM 504. WM 504 therefore uses the empty time slots of the synchronized WDs 506 to send synchronization information on the configuration channels, where the unsynchronized WDs 506 are listening for the sync frames. In this example, WD3 506.3 is listening for sync frames on configuration channel 39, so it will receive a sync frame 530. WD4 506.4 is listening for sync frames on configuration channel 38, so it will receive a sync frame 532.

Each of WDs 506.3 and 506.4 may receive their respective sync frame 530 and 532 sometime during SF 502B. Although FIG. 5A shows process 518 extending into SF 502B longer than process 516 extends into SF 502B, process 518 may end at the same time or earlier than the ending of process 516 in some examples.

As shown in FIG. 5A, WD3 506.3 becomes synchronized using the information from sync frame 530 in SF 502B. The sync frame 530 may include the current timestamp, the timestamp of the next expected DL frame from WM 504, and the data channel of the next expected DL frame. In this example, the data channel of the next expected DL frame is channel a3. Therefore, WD3 506.3 switches to channel a3 for the next SF (SF 502C, shown in FIG. 5B). Likewise, WD4 506.4 becomes synchronized using the information from sync frame 532 in SF 502B. WD4 506.4 also switches to channel a3 for the next SF (SF 502C, shown in FIG. 5B).

FIG. 5B shows super frame structure 500B. Super frame structure 500B includes a third SF 502C and a fourth SF 502D. In this example, WD2 and WD7 are not shown for simplicity. In SF 502C, WM 504 sends Tx 534 to the WDs 506 on data channel a3. Tx 534 may continue to include the schedule of sync frames for WD1 506.1, WD5 506.5, and WD6 506.6. The sync frame information in Tx 534 includes the current timestamp, the timestamp of the next SF 502D, and the channel for the next SF 502D (in this example, data channel a4). At the beginning of SF 502C, WM 504 does not yet know if the unsynchronized WDs 506 have been synchronized, as WM 504 has not received ULs from those WDs 506 at this time. Therefore, the selected WDs 506 (WD1 506.1, WD5 506.5, and WD6 506.6) will continue to send sync frames in SF 502C.

Here, WD1 506.1 receives Rx 536A, WD3 506.3 receives Rx 536B, WD4 506.4 receives Rx 536C, WD5 506.5 receives Rx 536D, and WD6 506.6 receives Rx 536E. Responsive to receiving the Rx 536, each synchronized WD 506 sends a Tx 538 back to WM 504 in the respective time slot for the WD 506 (shown as Tx 538A to 538E in SF 502C). The ULs received by WM 504 from each WD 506 are shown as Rx 540.1 to Rx 540.N. In this example, WM 504 receives an Rx 540 from every WD 506 (WD1 to WD7), and determines that all of the WDs 506 are now in synchronization.

WD1 506.1 sends sync frames 542 on configuration channel 37 (shown in FIG. 5B as Sync-37) in the time slots of SF 502C that are not used by WD1 506.1 to communicate with WM 504. WD5 506.5 sends sync frames 544 on configuration channel 39 (shown in FIG. 5B as Sync-39) in the time slots of SF 502C that are not used by WD5 506.5 to communicate with WM 504. WD6 506.6 sends sync frames 546 on configuration channel 38 (shown in FIG. 5B as Sync-38) in the time slots of SF 502C that are not used by WD6 506.6 to communicate with WM 504.

At the beginning of SF 502D, WM 504 has determined that all WDs 506 are synchronized. Therefore, WM 504 does not need to instruct any WDs 506 to send sync frames for SF 502D. WM 504 can instead send a Tx 548 that includes the instructions for normal operation to WDs 506. WM 504 sends Tx 548 on data channel a4 to each WD 506. The WDs 506 receive an Rx 550 from WM 504 (shown as Rx 550A to Rx 550E in SF 502D). The WDs 506 each send a Tx 552 back to WM 504 in their respective time slots in SF 502D (shown as Tx 552A to Tx 552E in SF 502D). WM 504 receives the ULs 554.1 to 554.N, and again determines that all WDs 506 are in synchronization.

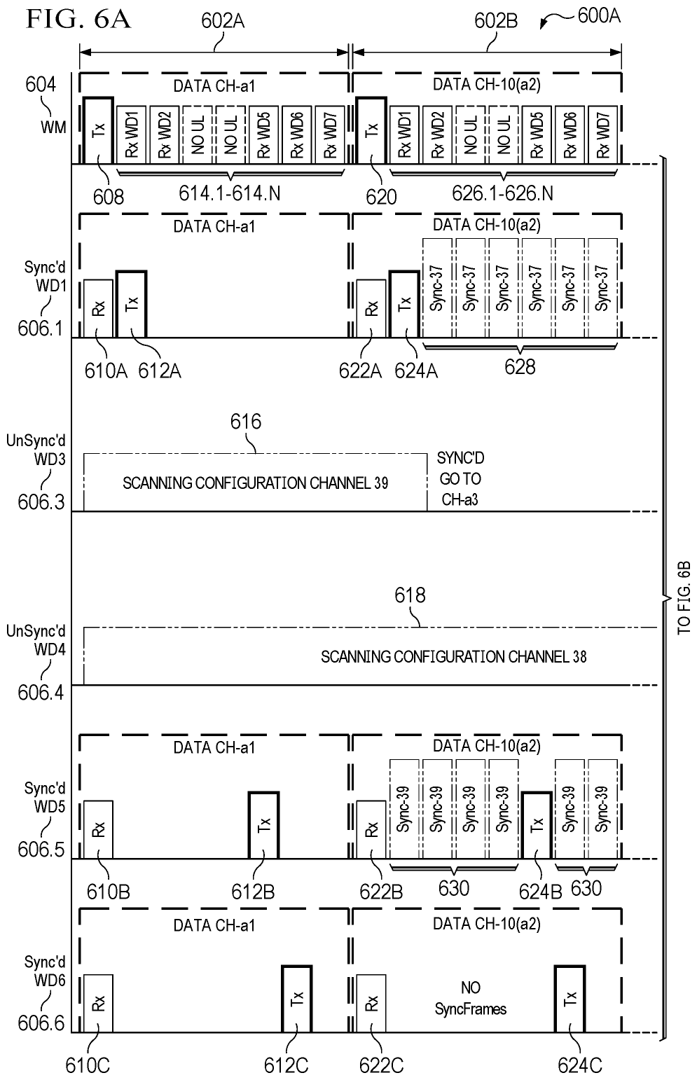

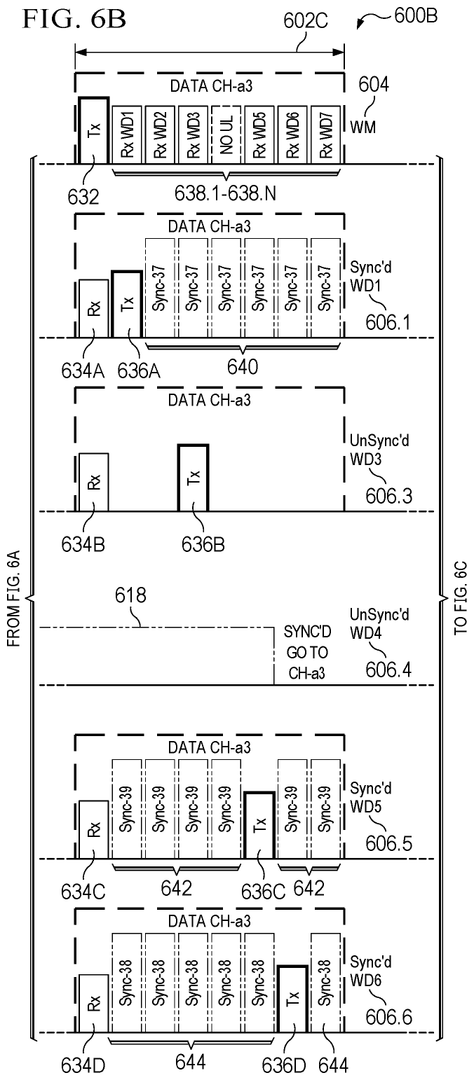

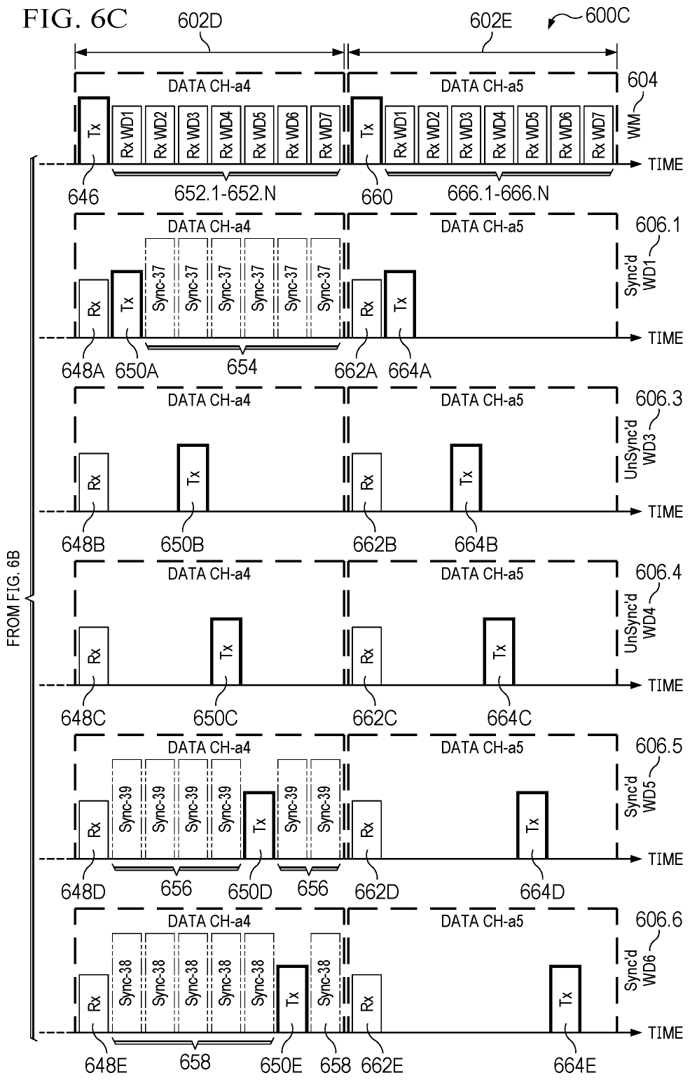

FIGS. 5A and 5B show one example node resynchronization process where synchronized WDs 506 are instructed by a WM 504 to transmit sync frames on various configuration channels. As described above, when WM 504 assigns configuration channels to synchronized WDs 506, WM 504 checks for adjacent channel interference using a predetermined adjacency rule. If the current data channel used for transmitting data between the WM 504 and the WDs 506 is adjacent to the assigned configuration channels 1, 2, or 3, then the WD 506 corresponding to the adjacent configuration channel is removed from the schedule created by the WM 504. This removal is performed to lessen the chances of interference among adjacent channels. FIGS. 6A and 6B provide an example of applying the adjacency rule.

FIGS. 6A, 6B, and 6C show a node resynchronization mechanism in accordance with various examples herein. FIG. 6A shows a super frame structure 600A, FIG. 6B shows a super frame structure 600B, and FIG. 6C shows a super frame structure 600C. The super frame structures 600A, 600B, and 600C includes ULs and DLs for various devices that are shown on the left side of FIGS. 6A, 6B, and 6C (WM 604, WD1 606.1, WD3 606.3, WD4 606.4, WD5 606.5, and WD6 606.6). The ULs and DLs shown in each row are the links either sent or received by the particular device listed on the left. In an example, WM 604 may be a primary network node 102 as described above, and the WDs 606 may be secondary network nodes 106.

Super frame structure 600A includes a first SF 602A and a second SF 602B. Super frame structure 600B includes a third SF 602C. Super frame structure 600C includes a fourth SF 602D and a fifth SF 602E. Super frame structures 600A, 600B, and 600C include various ULs and DLs 608 to 666. These ULs and DLs represent the communications between the devices in an example WBMS (e.g., WBMS 100). The details of each of the ULs and DLs 608 to 666 are described below.

Super frame structures 600A, 600B, and 600C also show the channels that the devices in WBMS 100 are using for communication. The channels may include both data channels and configuration channels. The particular ULs and DLs that are transmitted on each channel are described below.

FIGS. 6A, 6B, and 6C show one example node resynchronization process using super frame structures 600A, 600B, and 600C. In the first SF 602A in FIG. 6A, WM 604 sends Tx 608 to the WDs 606 on a data channel (in this example, data channel a1). Here, WD1 606.1 receives Rx 610A, WD5 606.5 receives Rx 610B, and WD6 606.6 receives Rx 610C. Tx 608 may contain instructions for the WDs 606 to provide information, such as a status of the battery cells 108 coupled to the respective WD 606. Responsive to receiving the Rx 610A, WD1 606.1 sends a Tx 612A back to WM 604 in a time slot of SF 602A assigned to WD1 606.1. Responsive to receiving the Rx 610B, WD5 606.5 sends a Tx 612B back to WM 604 in a time slot of SF 602A assigned to WD5 606.5. Responsive to receiving the Rx 610C, WD6 606.6 sends a Tx 612C back to WM 604 in a time slot of SF 602A assigned to WD6 606.6. The ULs received by WM 604 from each WD 606 are shown as Rx 614.1 to Rx 614.N, where the WBMS 100 includes N WDs 606 (N is 7 in this example).

In this example, WD3 606.3 and WD4 606.4 are unsynchronized. In SFs prior to SF 602A (not shown in FIG. 6A), WD3 606.3 and WD4 606.4 each determined that they had missed a certain number of DLs from WM 604. Responsive to this determination, WD3 606.3 and WD4 606.4 began scanning configuration channels in SF 602A. WD3 606.3 is scanning configuration channel 39 (process 616), and WD4 606.4 is scanning configuration channel 38 (process 618). The unsynchronized WDs 606 may scan any configuration channel responsive to determining that they are unsynchronized. The configuration channel to scan may be programmed, selected randomly, or selected with any suitable algorithm.

SF 602A shows the ULs received by WM 604 from the WDs 606 (Rx 614.1 to Rx 614.N). In this example, the WBMS 100 has seven WDs 606, but any number may be present in other examples. WD2 and WD7 are not shown in FIG. 6A, 6B, and 6C for simplicity. WM 604 receives ULs from WDs 1, 2, 5, 6, and 7 in this example. The ULs from WD3 606.3 and WD4 606.4 are shown as missing UL (“No UL”) in FIG. 6A. As described above, the WM 604 may have also missed these ULs from WD3 606.3 and WD4 606.4 in a number of SFs prior to SF 602A. Therefore, responsive to missing these ULs in SF 602A, WM 604 determines that a resynchronization process should begin in SF 602B.

The resynchronization process in SF 602B is similar to the process described above with respect to SF 502B. For the resynchronization process, WM 604 makes a list of synchronized and unsynchronized WDs 606 based on a previous superframe (such as SF 602A). In this example, WM 604 selects three synchronized WDs 606. A different number of WDs 606 may be selected in other examples. WM 604 then creates a schedule of resynchronization frames (sync frames) for the current SF 602B before transmitting its normal DL to the synchronized WDs 606. A configuration channel is assigned to each selected WD 606 by the WM 604.

In this example, WM 604 selects WD1 606.1, WD5 606.5, and WD6 606.6 to send sync frames to the unsynchronized WDs 606. WM 604 assigns a configuration channel to each selected WD 606. In this example, the configuration channels are channels 37, 38, and 39. The data channel a2 for SF 602B is channel 10 in this example. As shown in FIG. 4, data channel 10 is adjacent to configuration channel 38. Therefore, the WD 606 assigned configuration channel 38 is removed from the list of WDs 606 selected to send sync frames. Here, WM 604 assigned WD6 606.6 configuration channel 38. Because configuration channel 38 is adjacent to data channel 10, WM 604 will remove WD6 606.6, and WD6 606.6 will not send sync frames in SF 602B.

In SF 602B, WM 604 sends Tx 620 to the WDs 606. Tx 620 includes the sync frame information that WD1 606.1 and WD5 606.5 will send to the unsynchronized WDs 606. Tx 620 may also include the normal operating instructions for the WBMS 100, so the synchronized WDs 606 can continue to send their data to WM 604. In this example, Tx 620 is sent on data channel a2 (channel 10). WD1 606.1 receives Rx 622A, WD5 606.5 receives Rx 622B, and WD6 606.6 receives Rx 622C.

Responsive to receiving the Rx 622A, WD1 606.1 sends a Tx 624A back to WM 604 in a time slot of SF 602B assigned to WD1 606.1. Responsive to receiving the Rx 622B, WD5 606.5 sends a Tx 624B back to WM 604 in a time slot of SF 602B assigned to WD5 606.5. Responsive to receiving the Rx 622C, WD6 606.6 sends a Tx 624C back to WM 604 in a time slot of SF 602B assigned to WD6 606.6. The ULs received by WM 604 from each WD 606 are shown as Rx 626.1 to Rx 626.N. Once again, the ULs from WD3 606.3 and WD4 606.4 are missing in SF 602B.

In the node resynchronization process described herein, the selected WDs 606 transmit sync frames on the configuration channels in their otherwise open time slots in SF 602B. WD1 606.1 sends sync frames 628 on configuration channel 37 (shown in FIG. 6A as Sync-37) in the time slots of SF 602B that are not used by WD1 606.1 to communicate with WM 504. WD5 606.5 sends sync frames 630 on configuration channel 39 (shown in FIG. 6A as Sync-39) in the time slots of SF 602B that are not used by WD5 606.5 to communicate with WM 604. WD6 606.6 does not send sync frames in SF 602B due to being removed from the schedule via the adjacency rule described above. In this example, WD3 606.3 is listening for sync frames on configuration channel 39, so it will receive a sync frame 630. WD4 606.4 is listening for sync frames on configuration channel 38. Because no sync frames are sent on configuration channel 38 during SF 602B, WD4 606.4 does not receive a sync frame in SF 602B. WD4 606.4 continues to listen for sync frames in SF 602C.

In SF 602C in FIG. 6B, WM 604 again assigns synchronized WDs 606 to send sync frames to the unsynchronized WDs 606. WM 604 selects WD1 606.1, WD5 606.5, and WD6 606.6 to send sync frames to the unsynchronized WDs 606. Other WDs 606 could be selected in other examples. WM 604 assigns a configuration channel to each selected WD 606. In this example, the configuration channels are channels 37, 38, and 39. The data channel a3 for SF 602C is not adjacent to any of the configuration channels, so all three selected WDs 606 will send sync frames in SF 602C.

In SF 602C, WM 604 sends Tx 632 to the WDs 606. Tx 632 includes the sync frame information that WD1 606.1, WD5 606.5, and WD6 606.6 will send to the unsynchronized WDs 606. Tx 632 may also include the normal operating instructions for the WBMS 100, so the synchronized WDs 606 can continue to send their data to WM 604. In this example, Tx 632 is sent on data channel a3. WD1 606.1 receives Rx 634A, WD3 606.3 receives Rx 634B, WD5 606.5 receives Rx 634C, and WD6 606.6 receives Rx 634D.

Responsive to receiving the Rx 634, each of the WDs 606 that received the Rx 634 sends a Tx 636 back to WM 604 in the appropriate time slot for that WD 606. WD1 606.1 sends Tx 636A, WD3 606.3 sends Tx 636B, WD5 606.5 sends Tx 636C, and WD6 606.6 sends Tx 636D. The ULs received by WM 604 from each WD 606 are shown as Rx 638.1 to Rx 638.N. In SF 602C, the UL from WD4 606.4 is the only missing UL.

In the node resynchronization process described herein, the selected WDs 606 again transmit sync frames on the configuration channels in their otherwise open time slots in SF 602C. WD1 606.1 sends sync frames 640 on configuration channel 37 (shown in FIG. 6B as Sync-37). WD5 606.5 sends sync frames 642 on configuration channel 39 (shown in FIG. 6B as Sync-39). WD6 606.6 sends sync frames 644 on configuration channel 38 (shown in FIG. 6B as Sync-38). In this example, WD4 606.4 is listening for sync frames on configuration channel 38, so it will receive a sync frame 644 in SF 602C. Therefore, WD4 606.4 will synchronize and go to channel a4 for the next SF 602D.

FIG. 6C shows super frame structure 600C. Super frame structure 600C includes a fourth SF 602D and a fifth SF 602E. In this example, WD2 and WD7 are not shown for simplicity. In SF 602D, WM 604 sends Tx 646 to the WDs 506 on data channel a4. Tx 646 may continue to include the schedule of sync frames for WD1 606.1. WD5 606.5, and WD6 606.6. The sync frame information in Tx 646 includes the current timestamp, the timestamp of the next SF 602E, and the channel for the next SF 602E (in this example, data channel a5). At the beginning of SF 602D, WM 604 does not yet know if WD4 606.4 has been synchronized, as WM 604 has not received an UL from WD4 606.4 at this time. Therefore, the selected WDs 606 (WD1 606.1, WD5 606.5, and WD6 606.6) will continue to send sync frames in SF 602D.

Here, WD1 606.1 receives Rx 648A, WD3 606.3 receives Rx 648B, WD4 606.4 receives Rx 648C, WD5 606.5 receives Rx 648D, and WD6 606.6 receives Rx 648E. Responsive to receiving the Rx 648, each synchronized WD 606 sends a Tx 650 back to WM 604 in the respective time slot for the WD 606 (shown as Tx 650A to 650E in SF 602D). The ULs received by WM 604 from each WD 606 are shown as Rx 652.1 to Rx 652.N. In this example, WM 604 receives an Rx 652 from every WD 606 (WD1 to WD7), and determines that all of the WDs 606 are now in synchronization.

WD1 606.1 sends sync frames 654 on configuration channel 37 (shown in FIG. 6C as Sync-37) in the time slots of SF 602D that are not used by WD1 606.1 to communicate with WM 604. WD5 606.5 sends sync frames 656 on configuration channel 39 (shown in FIG. 6C as Sync-39) in the time slots of SF 602D that are not used by WD5 606.5 to communicate with WM 604. WD6 606.6 sends sync frames 658 on configuration channel 38 (shown in FIG. 6C as Sync-38) in the time slots of SF 602D that are not used by WD6 606.6 to communicate with WM 604.

At the beginning of SF 602E, WM 604 has determined that all WDs 606 are synchronized. Therefore, WM 604 does not need to instruct any WDs 606 to send sync frames for SF 602E. WM 604 can instead send a Tx 660 that includes the instructions for normal operation to WDs 606. WM 604 sends Tx 660 on data channel a5 to each WD 606. The WDs 606 receive an Rx 662 from WM 604 (shown as Rx 662A to Rx 662E in SF 602E). The WDs 606 each send a Tx 664 back to WM 604 in their respective time slots in SF 602E (shown as Tx 664A to Tx 664E in SF 602E). WM 604 receives the ULs 666.1 to 666.N, and again determines that all WDs 606 are in synchronization.

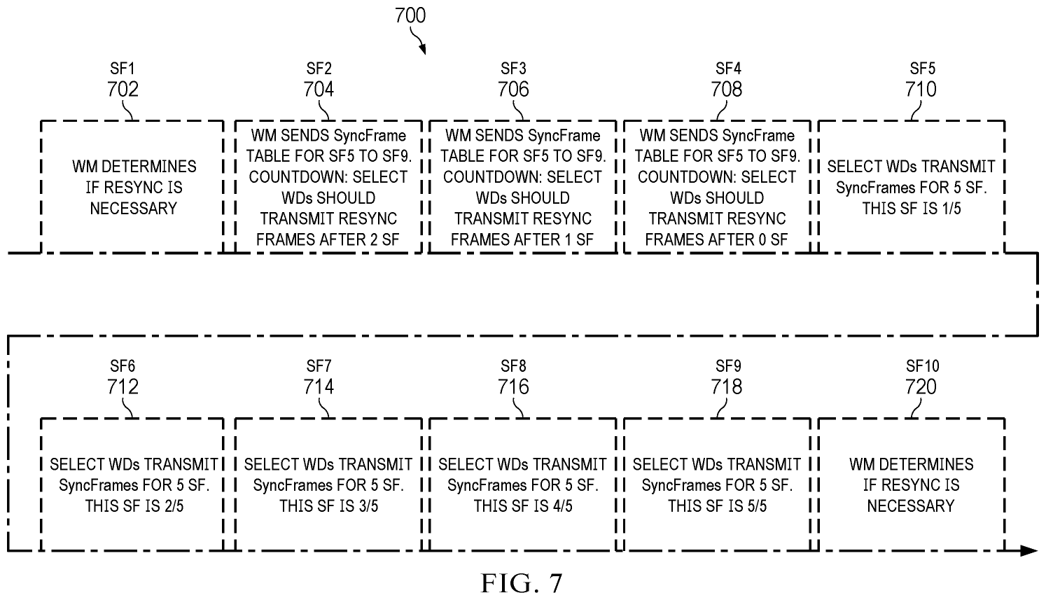

FIG. 7 is a countdown procedure for node resynchronization in accordance with various examples herein. In this example, the WM can implement a countdown process, where the selected synchronized WDs do not transmit the sync frames in the next super frame, but instead transmit the sync frames in a designated future super frame. The selected WD can acknowledge to the WM that the WD received the sync frame instruction. The WM can also wait to check for synchronization status until the designated future super frame, rather than checking every super frame. A countdown procedure as described herein may be performed if a resynchronization procedure as described above fails to resynchronize one or more WDs. In another example, if resynchronization fails using the procedures described above with respect to FIGS. 5A-6C, or if resynchronization fails using a countdown procedure, a procedure as described above with respect to FIG. 3 may be performed for resynchronization. The various resynchronization procedures described herein may be performed in any order.

In one example countdown procedure, the WM determines that resynchronization should be performed. Then, the WM looks ahead a certain selected number of super frames in the hopping sequence (such as 3 SFs, 5 SFs, 7 SFs, etc.). The WM allocates configuration channels to three selected synchronized WDs for the selected SFs after removing any interfering configuration channels in the selected SFs (by using the adjacency rules described herein). The WM has therefore created sync frame tables or schedules for the upcoming selected super frames. The WM communicates the sync frame tables in a DL frame to each WD, along with a countdown. The countdown is a selected number of super frames (e.g., countdown frames) for the WDs to wait before they begin transmitting sync frames. The selected WDs transmit the sync frames on the allocated configuration channels after the countdown is complete. Then, the WM can again check if resynchronization is needed.

FIG. 7 shows one example countdown procedure 700. At SF1 702, the WM determines if a resynchronization should be performed. At SF2 704, the WM sends the sync frame tables for the selected upcoming SFs. In this example, sync frames will be sent during SF5 to SF9. In SF2 704, the WM also begins the countdown. For the countdown, the selected WDs should transmit their sync frames after 2 SFs.

At SF3 706, the WM can again send the sync frame tables for the selected upcoming SFs (SF5 to SF9). The countdown continues, and the selected WDs should transmit their sync frames after 1 SF.

At SF4 708, the WM can again send the sync frame tables for the selected upcoming SFs (SF5 to SF9). The countdown continues, and the selected WDs should transmit their sync frames after 0 SFs.

At SF5 710, the selected WDs transmit their sync frames. The sync frames will be transmitted for five SFs (SF5 to SF9). SF5 710 is the first SF of the five SFs. At SF6 712, the selected WDs transmit their sync frames. SF6 712 is the second SF of the five SFs. At SF7 714, the selected WDs transmit their sync frames. SF7 714 is the third SF of the five SFs. At SF8 716, the selected WDs transmit their sync frames. SF8 716 is the fourth SF of the five SFs. At SF9 718, the selected WDs transmit their sync frames. SF9 718 is the fifth SF of the five SFs.

At SF10 720, the WM again determines if a resynchronization process is necessary. If so, the steps in FIG. 7 may be repeated for additional resynchronization.

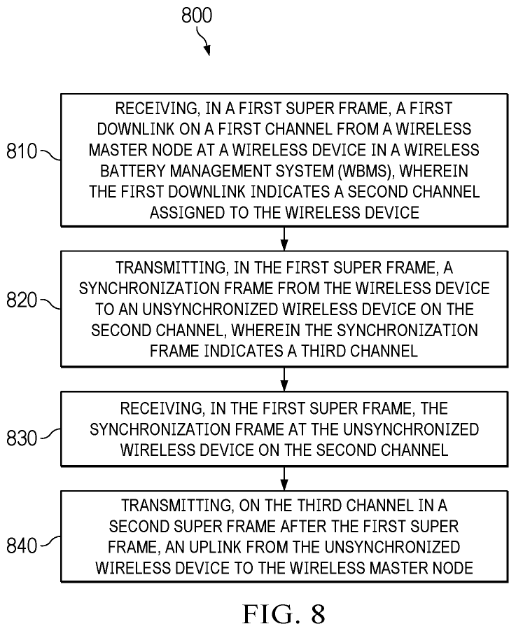

FIG. 8 is a flow diagram of a method 800 for node resynchronization in a WBMS in accordance with various examples herein. The steps of method 800 may be performed in any suitable order. The hardware components described above with respect to FIGS. 1-2B may perform method 800 in some examples. Any suitable hardware, software, or digital logic may perform method 800 in some examples.

Method 800 begins at 810, where a wireless device (WD) receives, in a first super frame, a first downlink on a first channel from a wireless master node in a WBMS, where the first downlink indicates a second channel assigned to the wireless device. As one example, the first channel may be a data channel al as described above. The second channel may be a configuration channel, such as channel 37, 38, or 39.

Method 800 continues at 820, where the WD transmits, in the first super frame, a synchronization frame from the WD to an unsynchronized WD on the second channel, where the synchronization frame indicates a third channel. The third channel in the synchronization frame may be the data channel for the next super frame after the first super frame. In some examples, the third channel may be the same as the first channel. In an example, if the first channel is data channel al. which is used for data transmission in the first super frame, the next super frame after the first super frame may re-use data channel al for data transmission. In other examples, the third channel may be different than the first channel.

Method 800 continues at 830, where the unsynchronized WD receives, in the first super frame, the synchronization frame on the second channel. As described above, the unsynchronized WD may switch to a configuration channel to listen for a sync frame upon becoming unsynchronized.

Method 800 continues at 840, where the unsynchronized WD transmits, on the third channel in a second super frame after the first super frame, an uplink to the wireless master node. The sync frame includes the third channel information, and the unsynchronized WD switches to the third channel for the second super frame so it can again become synchronized with the WM.

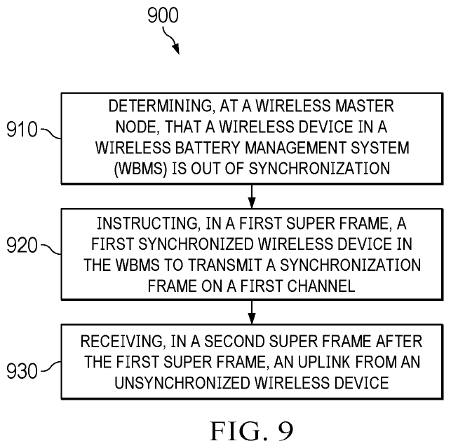

FIG. 9 is a flow diagram of a method 900 for node resynchronization in a WBMS in accordance with various examples herein. The steps of method 900 may be performed in any suitable order. The hardware components described above with respect to FIGS. 1-2B may perform method 900 in some examples. Any suitable hardware, software, or digital logic may perform method 900 in some examples.

Method 900 begins at 910, where a wireless master node (WM) determines that a wireless device (WD) in a WBMS is out of synchronization. The determination may be made using any suitable criteria. In one example, the WM determines that a WD is out of synchronization if the WM does not receive an UL from the WD for a specified number of consecutive super frames (such as 3, 5, or 9 SFs).

Method 900 continues at 920, where the WM instructs, in a first super frame, a first synchronized wireless device in the WBMS to transmit a synchronization frame on a first channel. The first channel may be a configuration channel in one example. The WM may instruct any number of WDs to transmit synchronization frames on various channels.

Method 900 continues at 930, where the WM receives, in a second super frame after the first super frame, an uplink from an unsynchronized wireless device. The second super frame may be immediately after the first super frame, or may be any number of super frames later. After receiving the UL, the WM may determine that the unsynchronized WD is now synchronized. The WM may receive the uplink from the unsynchronized wireless device during the second super frame on a data channel.

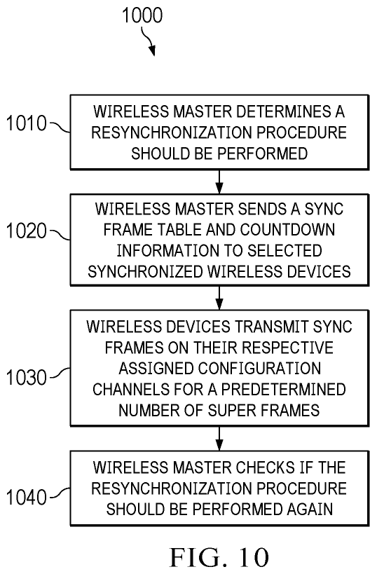

FIG. 10 is a flow diagram of a method 1000 for node resynchronization in a WBMS in accordance with various examples herein. FIG. 10 shows an example countdown procedure as described above with respect to FIG. 7. The steps of method 1000 may be performed in any suitable order. The hardware components described above with respect to FIGS. 1-2B may perform method 1000 in some examples. Any suitable hardware, software, or digital logic may perform method 1000 in some examples.

Method 1000 begins at 1010, where the WM determines that a resynchronization should be performed. The WM may make this determination based on a certain number of missed ULs from one or more WDs.

Method 1000 continues at 1020, where the WM sends a sync frame table and countdown information to selected synchronized WDs. The synchronized WDs that will send the sync frames may be selected as described above, or using any suitable technique. The sync frame table may include which configuration channel is assigned to which WD. The countdown information may be included in the sync frame table, and may indicate which super frame the WDs should begin transmitting sync frames. In some examples, the WM may re-send the sync frame table and updated countdown information in subsequent super frames, as described above with respect to FIG. 7.

Method 1000 continues at 1030, where the WDs transmit sync frames on their respective assigned configuration channels for a predetermined number of super frames. The WM may instruct the WDs to transmit sync frames for a certain number of super frames, such as three super frames, five super frames, etc. The configuration channels for transmission, and the WDs that are selected, may be selected by the WM looking ahead in the hopping sequence and selecting appropriate channels and WDs to avoid interference among adjacent channels during the super frames where the sync frames are transmitted. The configuration channels assigned to the WDs may also change each super frame.

Method 1000 continues at 1040, where the WM checks if the resynchronization procedure should be performed again. The WM may perform the resynchronization procedure again if there are still unsynchronized WDs, determined by the WM missing expected ULs from any WDs. If another resynchronization procedure should be performed, method 1000 can return to 1010 and perform method 1000 again.

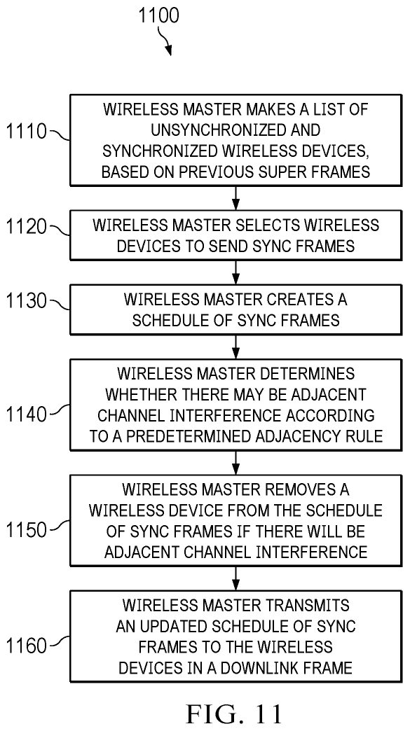

FIG. 11 is a flow diagram of a method 1100 for node resynchronization in a WBMS in accordance with various examples herein. FIG. 11 shows a method for applying adjacency rules as described above with respect to FIG. 4. The steps of method 1100 may be performed in any suitable order. The hardware components described above with respect to FIGS. 1-2B may perform method 1100 in some examples. Any suitable hardware, software, or digital logic may perform method 1100 in some examples.

Method 1100 begins at 1110, where the WM makes a list of unsynchronized and synchronized WDs, based on previous super frames. Any procedure may be useful for determining a WD is unsynchronized, such as the WD failing to send ULs to the WM for a certain number of frames. If there are one or more unsynchronized WDs, the WM begins the rejoin sequence.

Method 1100 continues at 1120, where the WM selects synchronized WDs to send sync frames. The WM may select three WDs in one example, but could select another number in other examples. In some examples, if three WDs are not available, the WM may use another rejoin technique, such as the process described above with respect to FIG. 3.

Method 1100 continues at 1130, where the WM creates a schedule of sync frames. The schedule may include which configuration channel is assigned to which selected synchronized WD. In some examples, the schedule includes three synchronized WDs, where each synchronized WD is assigned to one of three configuration channels.

Method 1100 continues at 1140, where the WM determines whether there may be adjacent channel interference according to a predetermined adjacency rule. If the current data channel used for transmitting data between the WM and the WDs is adjacent to the assigned configuration channels 1, 2, or 3, then the WD assigned to the adjacent configuration channel is removed from the schedule created by the WM. As described above, the adjacency rule can consider the transmission power spectrum characteristics, center frequency separation, and SNR requirements. A rule such as “must be separated by at least 2 channels” may be used in some examples.

Method 1100 continues at 1150, where the WM removes a WD from the schedule of sync frames if there will be adjacent channel interference. The WM produces an updated schedule of sync frames, without the WD that was removed due to the adjacency rule.

Method 1100 continues at 1160, where the WM transmits the updated schedule of sync frames to the WDs in a DL frame. After the WDs have received the DL frame with the sync frame information, the WDs can prepare sync frames as described herein to transmit on their assigned configuration channels.

In the examples herein, enlisting the synchronized WDs to help with node resynchronization avoids or reduces service disruption and data interruption of the WBMS, as compared to the WM transmitting the sync frames without help from the synchronized WDs. During the node resynchronization process, the WM can continue to send DLs to WDs, and the WDs that are synchronized can continue to respond to the WM in the appropriate time slots. In addition, nodes may be resynchronized quickly, such as within one super frame in some examples.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A method, comprising:
receiving, in a first super frame, a first downlink on a first channel from a wireless master node at a wireless device in a wireless battery management system (WBMS), wherein the first downlink indicates a second channel assigned to the wireless device;
transmitting, in the first super frame, a synchronization frame from the wireless device to an unsynchronized wireless device on the second channel, wherein the synchronization frame indicates a third channel;
receiving, in the first super frame, the synchronization frame at the unsynchronized wireless device on the second channel; and
transmitting, on the third channel in a second super frame after the first super frame, an uplink from the unsynchronized wireless device to the wireless master node.

2. The method of claim 1,
wherein the second channel is a configuration channel, and
wherein a frequency band of the configuration channel is not adjacent to a frequency band of the third channel.

3. The method of claim 1, wherein the wireless device transmits multiple synchronization frames on the second channel in the first super frame.

4. The method of claim 1, wherein the synchronization frame includes a current timestamp.

5. The method of claim 1, wherein the synchronization frame includes a timestamp of a next expected downlink frame.

6. The method of claim 1, wherein the first downlink indicates a number of countdown frames for the wireless device.

7. The method of claim 1, wherein the first downlink also indicates a fourth channel assigned to a third wireless device in the WBMS.

8. A method, comprising:
determining, at a wireless master node, that a wireless device in a wireless battery management system (WBMS) is out of synchronization;
instructing, in a first super frame, a first synchronized wireless device in the WBMS to transmit a synchronization frame on a first channel; and
receiving, in a second super frame after the first super frame, an uplink from an unsynchronized wireless device.

9. The method of claim 8, further comprising instructing, in the first super frame, a second synchronized wireless device in the WBMS to transmit the synchronization frame on a second channel.

10. The method of claim 9, further comprising instructing, in the first super frame, a third synchronized wireless device in the WBMS to transmit the synchronization frame on a third channel.

11. The method of claim 8, wherein the synchronization frame indicates a data channel for sending the uplink to the wireless master node.

12. The method of claim 8, wherein the synchronization frame includes a current timestamp.

13. The method of claim 8, wherein the synchronization frame includes a timestamp of a next expected downlink frame.

14. The method of claim 8, wherein the first channel is a configuration channel.

15. The method of claim 14,
wherein receiving the uplink from the unsynchronized wireless device comprises receiving the uplink on a data channel; and
wherein a frequency band of the data channel is not adjacent to a frequency band of the configuration channel.

16. The method of claim 8, further comprising:
instructing, in the first super frame, the first synchronized wireless device to wait a predetermined number of super frames before transmitting the synchronization frame.

17. A wireless master node in a wireless battery management system (WBMS) comprising:
a transceiver circuit; and
a processing circuit configured to:
determine that a wireless device in the WBMS is out of synchronization; and
instruct, in a first super frame via the transceiver circuit, a first synchronized wireless device in the WBMS to transmit a synchronization frame on a first channel,
wherein the transceiver circuit is configured to receive, in a second super frame after the first super frame, an uplink from an unsynchronized wireless device.

18. The wireless master node of claim 17, wherein the processing circuit is further configured to instruct, in the first super frame, a second synchronized wireless device in the WBMS to transmit the synchronization frame on a second channel.

19. The wireless master node of claim 17, wherein the synchronization frame includes a data channel for sending the uplink to the wireless master node.

20. The wireless master node of claim 17, wherein the first channel is a configuration channel.
wherein the transceiver circuit is configured to receive the uplink from the unsynchronized wireless device on a data channel, and
wherein a frequency band of the data channel is not adjacent to a frequency band of the configuration channel.
